(19) United States
(12) Patent Application Publication
(10) Pub. No.: US 2020/0145929 A1
(43) Pub. Date: May 7, 2020

(54) POWER CONTROL FOR MULTI-PANEL TRANSMISSION

(71) Applicant: QUALCOMM Incorporated, San Diego, CA (US)

(72) Inventors: Jung Ho RYU, Fort Lee, NJ (US); Tianyang BAI, Bridgewater, NJ (US); Kiran VENUGOPAL, Raritan, NJ (US); Makesh Pravin JOHN WILSON, San Diego, CA (US); Tao LUO, San Diego, CA (US)

(21) Appl. No.: 16/670,799

(22) Filed: Oct. 31, 2019

Related U.S. Application Data
(60) Provisional application No. 62/754,371, filed on Nov. 1, 2018.

(51) Int. Cl. H04W 52/24; H04W 72/04; H04L 5/00; H04W 52/36; H04W 52/32; H01Q 21/06

(52) U.S. Cl. CPC H04W 52/242; H04W 72/042; H04L 5/0048; H04L 27/2601; H04W 52/325; H01Q 21/06; H04W 52/367

(57) ABSTRACT

Certain aspects of the present disclosure are generally directed to apparatus and techniques for wireless communication. One example method generally includes determining at least one transmit power for transmission of one or more frames, the at least one transmit power being determined based on a first path loss associated with a first transmit direction and a second path loss associated with a second transmit direction, generating the frames, and transmitting the one or more frames in the first transmit direction and the second transmit direction using the determined transmit power.

### CROSS-REFERENCE TO RELATED APPLICATIONS

This application claims benefit of U.S. Provisional Patent Application Ser. No. 62/754,371, filed Nov. 1, 2018, which is expressly incorporated herein by reference in its entirety.

### FIELD OF THE DISCLOSURE

Aspects of the present disclosure relate to wireless communications, and more particularly, to techniques for power control.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication. The method generally includes determining at least one transmit power for transmission of one or more frames, the at least one transmit power being determined based on a first path loss associated with a first transmit direction and a second path loss associated with a second transmit direction, generating the frames, and transmitting the one or more frames in the first transmit direction and the second transmit direction using the determined transmit power.

Certain aspects provide a method for wireless communication. The method generally includes selecting an antenna array of a plurality of antenna arrays for transmission of one or more frames, determining a transmit power for the transmission of the one or more frames via the antenna array, the transmit power being determined based on a path loss associated with the selected antenna array, generating the one or more frames, and transmitting the one or more frames via the antenna array using the determined transmit power.

Certain aspects provide an apparatus for wireless communication. The apparatus generally includes a processing system configured to determine at least one transmit power for transmission of one or more frames, the at least one transmit power being determined based on a first path loss associated with a first transmit direction and a second path loss associated with a second transmit direction, generate the frames, and a transmitter configured to transmit the one or more frames in the first transmit direction and the second transmit direction using the determined transmit power.

Certain aspects provide an apparatus for wireless communication. The apparatus generally includes a processing system configured to select an antenna array of a plurality of antenna arrays for transmission of one or more frames, determine a transmit power for the transmission of the one or more frames via the antenna array, the transmit power being determined based on a path loss associated with the selected antenna array, generate the one or more frames, and a transmitter configured to transmit the one or more frames via the antenna array using the determined transmit power.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example base station (BS) and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a frame format for a new radio (NR) system, in accordance with certain aspects of the present disclosure.

FIG. 7 is a flow diagram illustrating operations for determining transmit power based on path losses corresponding to different transmit directions, in accordance with certain aspects of the present disclosure.

FIG. 8 is a flow diagram illustrating operations for determining transmit power of a selected antenna array, in accordance with certain aspects of the present disclosure.

FIG. 9 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for power control.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

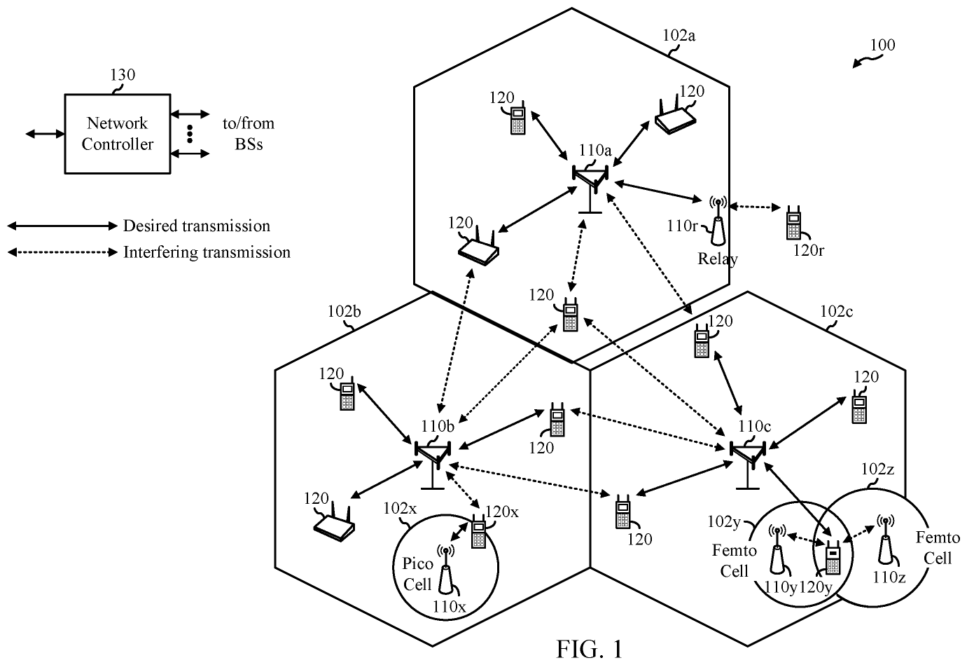

FIG. 1 illustrates an example wireless communication network 100 in which aspects of the present disclosure may be performed. For example, the wireless communication network 100 may be a New Radio (NR) or 5G network.

As illustrated in FIG. 1, the wireless communication network 100 may include a number of base stations (BSs) 110 and other network entities. ABS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). ABS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

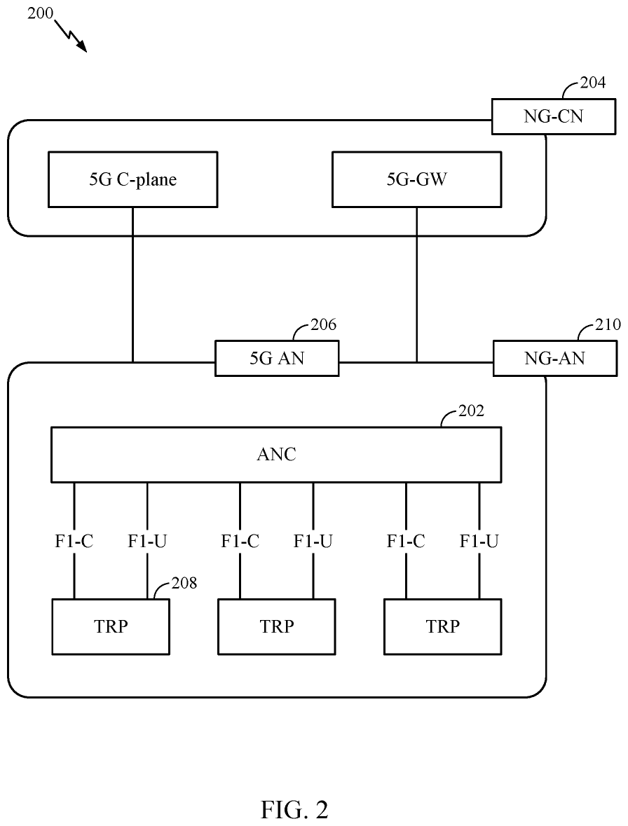

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

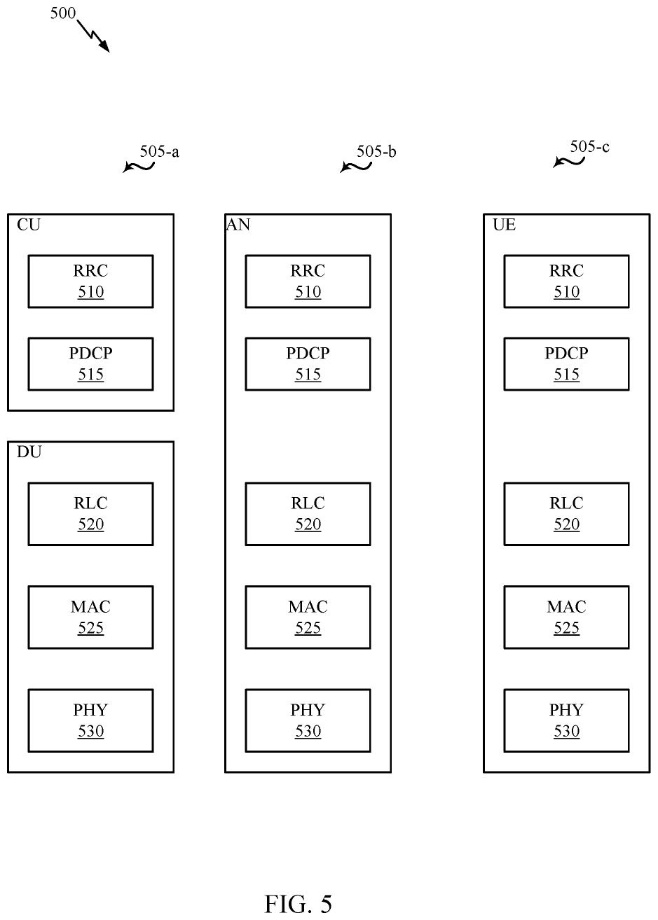

Logical functions may be dynamically distributed in the logical architecture of distributed RAN 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

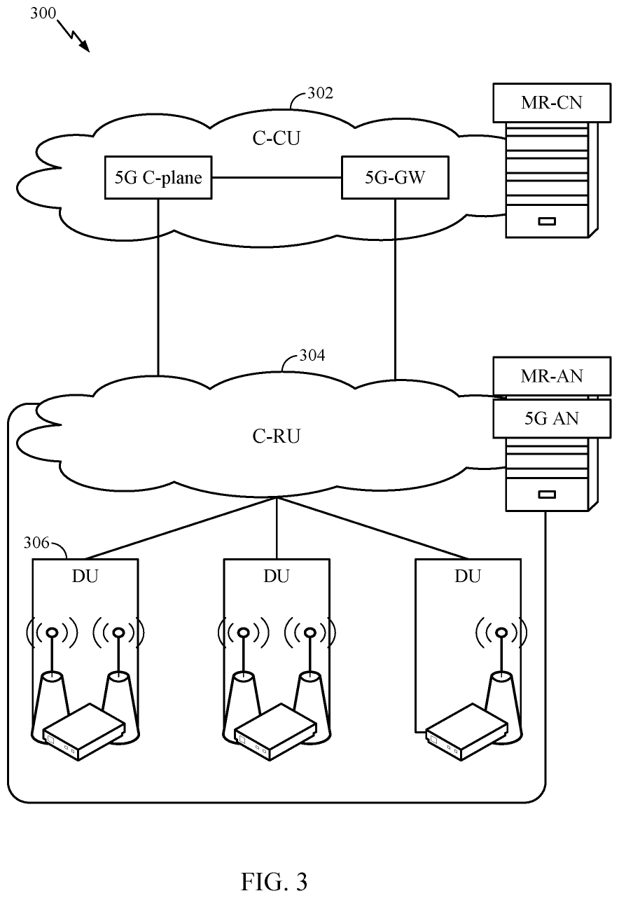

FIG. 3 illustrates an example physical architecture of a distributed RAN 300, according to aspects of the present disclosure. A centralized core network unit (C-CU) 302 may host core network functions. C-CU 302 may be centrally deployed. C-CU 302 functionality may be offloaded (e.g., to advanced wireless services (AWS)), in an effort to handle peak capacity.

A centralized RAN unit (C-RU) 304 may host one or more ANC functions. Optionally, the C-RU 304 may host core network functions locally. The C-RU 304 may have distributed deployment. The C-RU 304 may be close to the network edge.

A DU 306 may host one or more TRPs (Edge Node (EN), an Edge Unit (EU), a Radio Head (RH), a Smart Radio Head (SRH), or the like). The DU may be located at edges of the network with radio frequency (RF) functionality.

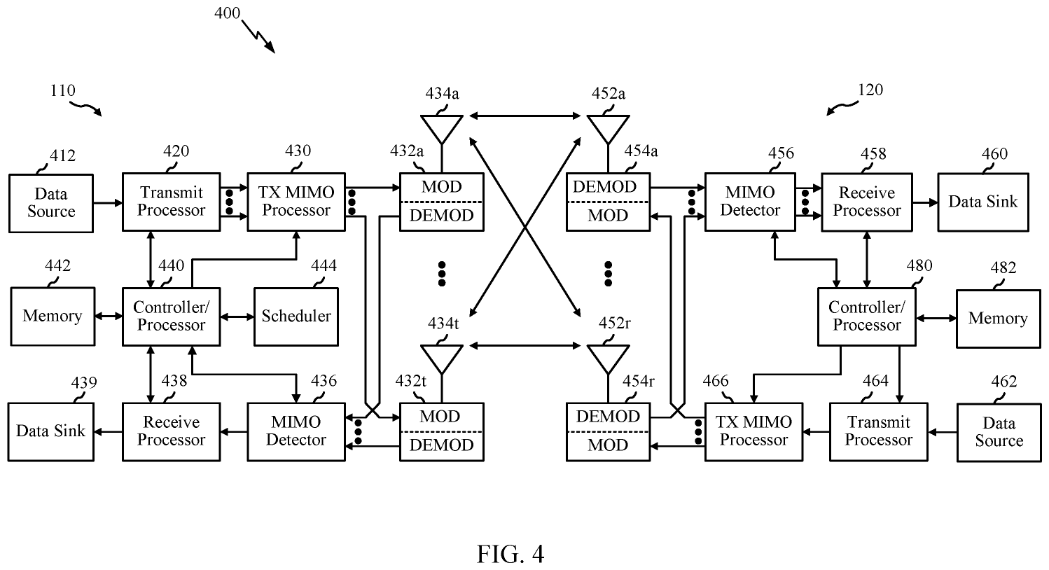

FIG. 4 illustrates example components of BS 110 and UE 120 (as depicted in FIG. 1), which may be used to implement aspects of the present disclosure. For example, antennas 452, processors 466, 458, 464, and/or controller/processor 480 of the UE 120 and/or antennas 434, processors 420, 430, 438, and/or controller/processor 440 of the BS 110 may be used to perform the various techniques and methods described herein.

At the BS 110, a transmit processor 420 may receive data from a data source 412 and control information from a controller/processor 440. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 420 may process (e.g., encode and symbol map) the data and control information to obtain data symbols and control symbols, respectively. The processor 420 may also generate reference symbols, e.g., for the primary synchronization signal (PSS), secondary synchronization signal (SSS), and cell-specific reference signal (CRS). A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. Each modulator 432 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) in transceivers 454a through 454r, respectively. Each demodulator 454 may condition (e.g., filter, amplify, downconvert, and digitize) a respective received signal to obtain input samples. Each demodulator may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. A receive processor 458 may process (e.g., demodulate, deinterleave, and decode) the detected symbols, provide decoded data for the UE 120 to a data sink 460, and provide decoded control information to a controller/processor 480.

On the uplink, at UE 120, a transmit processor 464 may receive and process data (e.g., for the physical uplink shared channel (PUSCH)) from a data source 462 and control information (e.g., for the physical uplink control channel (PUCCH) from the controller/processor 480. The transmit processor 464 may also generate reference symbols for a reference signal (e.g., for the sounding reference signal (SRS)). The symbols from the transmit processor 464 may be precoded by a TX MIMO processor 466 if applicable, further processed by the demodulators in transceivers 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the BS 110 and the UE 120, respectively. The processor 440 and/or other processors and modules at the BS 110 may perform or direct the execution of processes for the techniques described herein. The memories 442 and 482 may store data and program codes for BS 110 and UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a wireless communication system, such as a 5G system (e.g., a system that supports uplink-based mobility). Diagram 500 illustrates a communications protocol stack including a RRC layer 510, a PDCP layer 515, a RLC layer 520, a MAC layer 525, and a PHY layer 530. In various examples, the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device. In the second option, RRC layer 510, PDCP layer 515, RLC layer 520, MAC layer 525, and PHY layer 530 may each be implemented by the AN. The second option 505-b may be useful in, for example, a femto cell deployment.

Regardless of whether a network access device implements part or all of a protocol stack, a UE may implement an entire protocol stack as shown in 505-c (e.g., the RRC layer 510, the PDCP layer 515, the RLC layer 520, the MAC layer 525, and the PHY layer 530).

In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

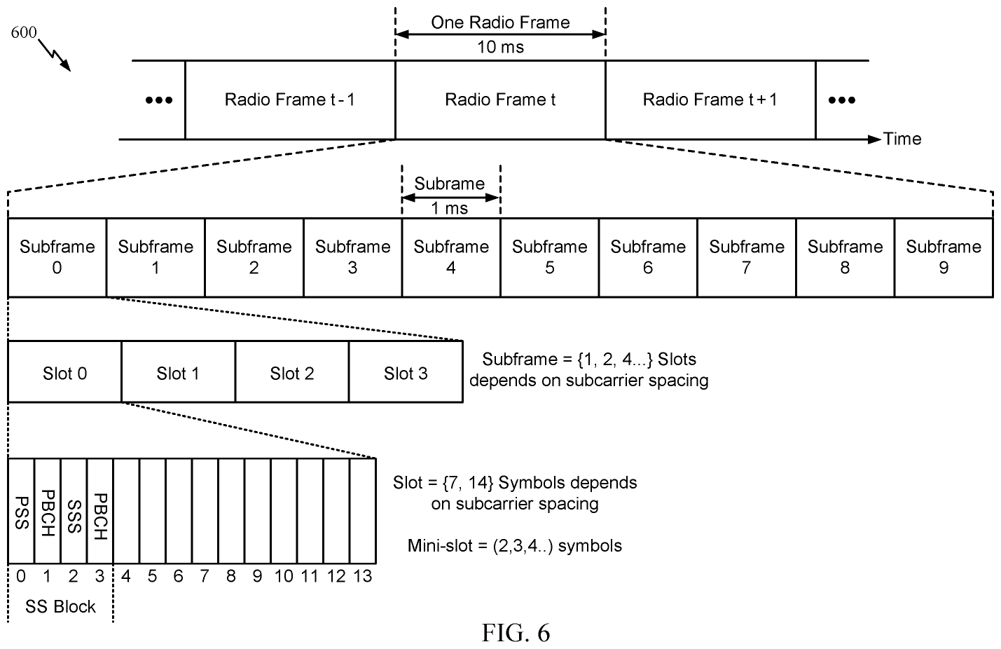

FIG. 6 is a diagram showing an example of a frame format 600 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 6. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Power Control Techniques

Certain aspects of the present disclosure provide power control techniques for uplink transmission. A UE may have multiple antenna arrays (e.g., also referred to as panels). Each of the antenna arrays covers a different direction in space (e.g., transmit direction). A UE may use the multiple antenna arrays simultaneously to transmit for increased data rate or reliability. However, transmitting from multiple panels may involve different power allocations over multiple panels. For example, a UE may have two panels. One panel may have good path loss, and the other may have acceptable path loss. The panel with the worse path loss may be allocated more transmit power so that the links from both panels are about the same. Certain aspects of the present disclosure provide techniques for uplink (UL) transmit power control loop that takes into account simultaneous transmissions from multiple panels.

Certain aspects of the present disclosure associate each of multiple sounding reference signal (SRS)-resource sets with a panel (e.g., antenna array) for both ‘codebook’ and ‘noncodebook’ based physical uplink shared channel (PUSCH) transmission. For example, an SRS resource indicator (SRI) field in downlink control information (DCI) may be used to select multiple SRS-resources from multiple SRS-resource sets, each set associated with a panel (e.g., antenna array). In some cases, one SRS resource set may be associated with multiple antennas. In certain aspects, DCI may indicate one or more panels for which path loss is to be determined based one or more reference signals associated with the indicated panels. For example, the path loss for each of the one or more indicated panels may be determined based on SRS resources of one or more SRS resource sets.

The SRS resources may be used to determine the path losses of antenna arrays, which are then used for determining transmission power as described herein. For example, a table may be defined that maps the SRI field of the DCI to an SRS-resource and an SRS-resource set that is to be used for multi panel transmission. The path losses of antenna arrays may be determined in association to specific reference signals. For instance, different antenna arrays may be associated with different reference signals, and thus result in the determination of different path losses for the antenna arrays. In some cases, an antenna array may be associated with multiple reference signals, and the path loss for each antenna array and the associated reference signal may be different.

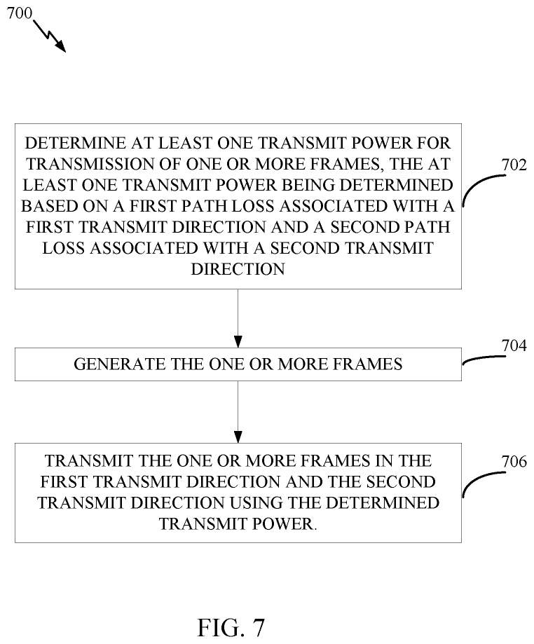

FIG. 7 is a flow diagram of example operations 700 for wireless communication, in accordance with certain aspects of the present disclosure. The operations 700 may be performed by a UE, such as the UE 120.

Operations 700 may be implemented as software components that are executed and run on one or more processors (e.g., controller/processor 480 of FIG. 4). Further, the transmission and reception of signals by the UE in operations 700 may be enabled, for example, by one or more antennas (e.g., antennas 452 of FIG. 4). In certain aspects, the transmission and/or reception of signals by the UE may be implemented via a bus interface of one or more processors (e.g., controller/processor 480) obtaining and/or outputting signals.

The operations 700 begins, at block 702, with the UE determining at least one transmit power for transmission of one or more frames (e.g., of a physical uplink shared channel (PUSCH)), the at least one transmit power being determined based on a first path loss associated with a first transmit direction and a second path loss associated with a second transmit direction. The first transmit direction and the second transmit direction may correspond to different antenna arrays, or different beams (e.g., reference signals), as will be described in more detail herein.

The operations 700 may also include, at block 704, the UE generating the one or more frames, and at block 706, transmitting the one or more frames in the first transmit direction and the second transmit direction using the determined transmit power.

In certain aspects, the first path loss may be associated with a first antenna array for transmission in the first transmit direction, and the second path loss may be associated with a second antenna array for transmission in the second transmit direction. In this case, the one or more frames may be transmitted in the first transmit direction and the second transmit direction via the first antenna array and the second antenna array. As described herein, the UE may receive a first indication (e.g., via DCI) of the first antenna array, and receive a second indication (e.g., via DCI) of the second antenna array. For example, the first indication of the first antenna array may include a first indication of a first SRS resource of a first SRS resource set, the first SRS resource set being associated with the first antenna array, and the second indication of the second antenna array may be a second indication of a second SRS resource of a second SRS resource set, the second SRS resource set being associated with the second antenna array. In some cases, the first SRS resource set and the second SRS resource may be different. The UE may determine the first path loss associated with the first antenna array based on a first reference signal (e.g., the first SRS resource) associated with the first antenna array in response to the first indication, and determine the second path loss associated with the second antenna array based on a second reference signal (e.g., the second SRS resource) associated with the second antenna array in response to the second indication.

In certain aspects, the transmit power (e.g., PUSCH transmit power (P_{PUSCH})) may be calculated (determined) based on the following equation. For example, if a UE transmits a PUSCH on UL bandwidth part (BWP) b of carrier f of serving cell c using parameter set configuration with index j and PUSCH power control adjustment state with index 1, the UE may determine the PUSCH transmission power P_{PUSCH,f,c}(i,j,q_{d}(p),l,p) in PUSCH transmission period i as follows:

$${P}_{PUSCH , b , f , c} ( i , j , {q}_{d} ( p ) , l , p ) = min \{ \begin{matrix}{P}_{CMAX , f , c} ( i ) , \\ {P}_{O \_ PUSCH , b , f , c} ( j ) + 10 log ( {2}^{μ} \cdot {M}_{RB , b , d , c}^{PUSCH} ( i ) ) + \\ {α}_{b , f , c} ( j ) {f}_{p} ( {PL}_{b , f , c} ( {q}_{d} ( 1 ) , 1 ) , … , {PL}_{b , f , c} ( {q}_{d} ( {N}_{p} ) , {N}_{p} ) ) + \\ {Δ}_{TF , b , f , c} ( i , p ) + {f}_{b , f , c} ( i , l )\end{matrix}$$

where p is the index of the antenna array/panel selected for UL transmission, q_{d}(p) is the reference signal index associated with panel p, P_{CMAX,f,c}(i) is the configured UE maximum transmit power for carrier f of serving cell c in PUSCH transmission period i, P_{O_PUSCH,b,ƒ,c}(j) corresponds to the target receive power of the base station. 10 log (2^{μ}·M_{RB,b,d,c}^{PUSCH}(i)) is a factor corresponding to bandwidth (e.g., larger bandwidth correspond to higher transmit power). For example, M_{RB,b,d,c}^{PUSCH}(i) is the bandwidth of the PUSCH resource assignment expressed in number of resource blocks for PUSCH transmission period i on UL BWP b of carrier f of serving cell c. μ is the subcarrier spacing configuration. α_{b,ƒ,c}(j) is a factor between 0 and 1 for reducing interference for cell edge UEs.

ƒₚ(PL_{b,ƒ,c}(q_{d}(1),1), . . . , PL_{b,ƒ,c}(q_{d}(Nₚ), Nₚ)) is a function of path losses associated with antenna array p. In certain aspects, the function ƒₚ may be different for calculating the transmit power of each of the antenna arrays. PL_{b,ƒ,c}(q_{d}(1),1), . . . , PL_{b,ƒ,c}(q_{d}(Nₚ), Nₚ) corresponds to downlink path-loss estimate in dB calculated by the UE using reference signal (RS) resource q_{d}(p) for UL BWP b of carrier f of serving cell c, for each of antenna arrays 1 to Nₚ, Nₚ being the total number of antenna arrays at the UE. Δ_{TF,b,f,c}(i,p) is a modulation and coding scheme (MCS) adjustment factor given that higher order modulations correspond to higher power transmissions. As illustrated, the MCS adjustment factor may be specific to the antenna array p. In other words, the Δ_{TF,b,f,c} (i, p) may be set for each of the antenna arrays based on an MCS used for transmission via the respective antenna array f_{b,f,c}(i, l) is a transmit power control (TPC) command adjustment (e.g., TPC adjustment command from the base station). In some cases, when the total power is larger than P_{CMAX}, the power for each panel may be scaled down to meet the P_{CMAX}. The scaling for each panel may be a function of the path loss determined based on the reference signals.

In certain aspects, the transmit power (e.g., PUSCH transmit power (P_{PUSCH})) may be calculated based on the following equation.

$${P}_{PUSCH , b , f , c} ( i , j , {q}_{d} ( p ) , l ) = min \{ \begin{matrix}{P}_{CMAX , f , c} ( i ) , \\ {P}_{O \_ PUSCH , b , f , c} ( j ) + 10 log ( {2}^{μ} \cdot {M}_{RB , b , d , c}^{PUSCH} ( i ) ) + \\ {α}_{b , f , c} ( j ) \cdot ( 1 / \vert {N}_{p} \vert {\sum }_{p ′} {PL}_{b , f , c} ( {q}_{d} ( {p}^{′} ) , {p}^{′} ) ) + {Δ}_{TF , b , f , c} ( i , p ) + {f}_{b , f , c} ( i , l )\end{matrix}$$

In this case, the same power control loop applies to all antenna arrays for the UE. For example, a function of the path losses of the antenna arrays, such as an average, maximum, minimum, or any other function may be applied based on the path losses associated with the antenna arrays to determine a transmit power which may be applied for transmission via all the antenna arrays. For instance, an average of the path losses may be calculated based on the following equation, to be used for calculating the transmit power.

$$1 / \vert {N}_{p} \vert {\sum }_{p ′} {PL}_{b , f , c} ( {q}_{d} ( {p}^{′} ) , {p}^{′} )$$

In certain aspects, the function may be a minimum of two or more path losses or the maximum of the two or more path losses, as opposed to an average of the path losses.

In certain aspects, the SRI field in the DCI may be used to select multiple SRS-resources from one SRS-resource set for PUSCH transmission from an antenna array. Out of the multiple SRS-resources selected by the gNB and indicated by the SRI field, the UE selects one or more to use for UL transmission. For example, the UE may detect that an object (e.g., human body) is next to the UE, and may select the SRS-resource corresponding to a beam having a transmit direction that is away from the detected object. In certain aspects, the transmit power (e.g., PUSCH transmit power (P_{PUSCH})) may be calculated based on the following equation, where a function ƒ(PL_{b,ƒ,c}(q_{d}_{₁}), PL_{b,ƒ,c}(q_{d}_{₂}) of path losses corresponding to different reference signals q_{d1}, q_{d2} associated with different SRS-resources may be used to determine the transmit power.

$${P}_{PUSCH , b , f , c} ( i , j , {{q}_{d}}_{1} , {q}_{{d}_{2}} , l ) = min \{ \begin{matrix}{P}_{CMAX , f , c} ( i ) , \\ {P}_{O \_ PUSCH , b , f , c} ( j ) + 10 log ( {2}^{μ} \cdot {M}_{RB , b , d , c}^{PUSCH} ( i ) ) + \\ {α}_{b , f , c} ( j ) \cdot f ( {PL}_{b , f , c} ( {q}_{{d}_{1}} ) , {PL}_{b , f , c} ( {q}_{{d}_{2}} ) ) + {Δ}_{TF , b , f , c} ( i ) + {f}_{b , f , c} ( i , l )\end{matrix}$$

In certain aspects, an antenna array of the multiple antenna arrays may be selected by the UE for data transmission. For example, the UE may detect an object (e.g., human body) towards a front side of the UE, and select an antenna array disposed on the back side of the UE to avoid transmission towards the human body.

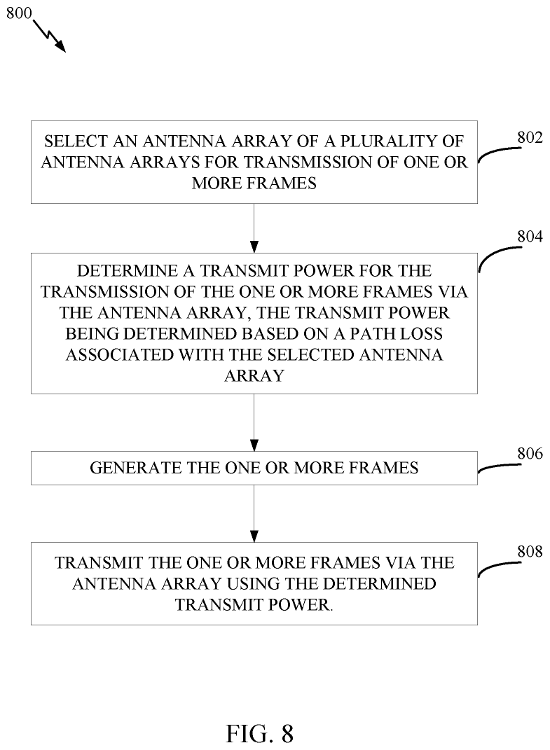

FIG. 8 is a flow diagram of example operations 800 for wireless communication, in accordance with certain aspects of the present disclosure. The operations 800 may be performed by a UE, such as the UE 120.

Operations 800 may be implemented as software components that are executed and run on one or more processors (e.g., controller/processor 480 of FIG. 4). Further, the transmission and reception of signals by the UE in operations 800 may be enabled, for example, by one or more antennas (e.g., antennas 452 of FIG. 4). In certain aspects, the transmission and/or reception of signals by the UE may be implemented via a bus interface of one or more processors (e.g., controller/processor 480) obtaining and/or outputting signals.

The operations 800 begins, at block 802, with the UE selecting an antenna array of a plurality of antenna arrays for transmission of one or more frames, and at block 804, determining a transmit power for the transmission of the one or more frames via the antenna array, the transmit power being determined based on a path loss associated with the selected antenna array. At block 806, the UE generates the one or more frames, and at block 808, transmits the one or more frames via the antenna array using the determined transmit power. For example, the transmit power may be determined based on the following equation, wherein p* corresponds to the selected antenna array:

$${P}_{PUSCH , b , f , c} ( i , j , {q}_{d} ( p *) , l ) = min \{ \begin{matrix}{P}_{CMAX , f , c} ( i ) , \\ {P}_{O \_ PUSCH , b , f , c} ( j ) + 10 log ( {2}^{μ} \cdot {M}_{RB , b , d , c}^{PUSCH} ( i ) ) + \\ {α}_{b , f , c} ( j ) \cdot {PL}_{b , f , c} ( {q}_{d} ( p *) , {p}^{*} ) + {Δ}_{TF , b , f , c} ( i , {p}^{*} ) + {f}_{b , f , c} ( i , l )\end{matrix}$$

where PL_{b,ƒ,c}(q_{d}(p*),p*) is the path loss of the selected antenna, and Δ_{TF,b,f,c} (i, p*) is the MCS adjustment factor for the selected antenna array.

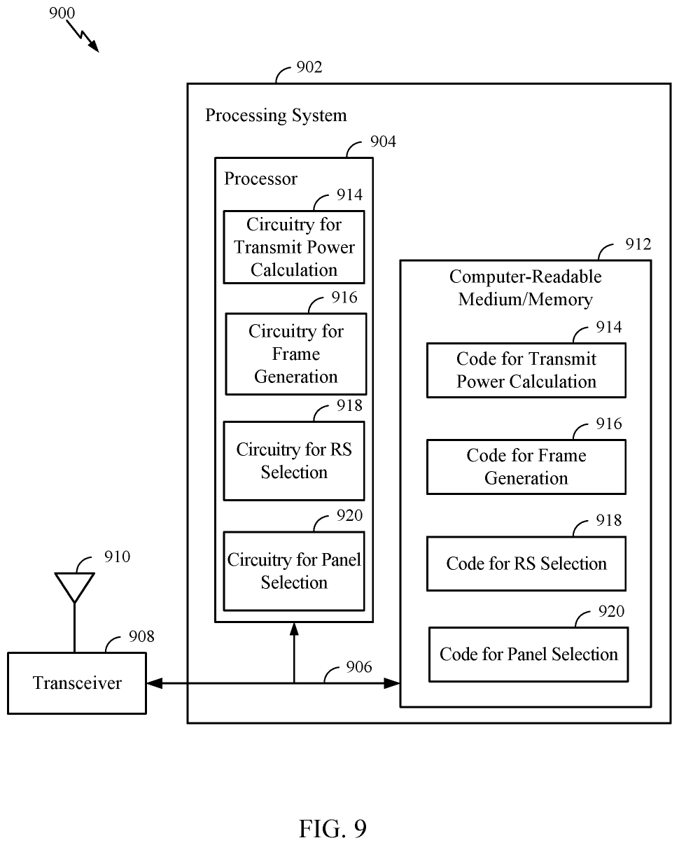

FIG. 9 illustrates a communications device 900 that may include various components (e.g., corresponding to means-plus-function components) configured to perform operations for the techniques disclosed herein, such as the operations illustrated in FIGS. 7 and 8. The communications device 900 includes a processing system 902 coupled to a transceiver 908. The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer executable code) that when executed by the processor 904, cause the processor 904 to perform the operations illustrated in FIGS. 7 and 8, or other operations for performing the various techniques discussed herein. In certain aspects, computer-readable medium/memory 912 stores code for transmit power calculation (determination) 914, code for frame generation 916, code for RS (beam) selection 918, and code for panel (antenna array) selection 920. In certain aspects, the processor 904 has circuitry configured to implement the code stored in the computer-readable medium/memory 912. The processor 904 includes circuitry for transmit power calculation (determination) 914, circuitry for frame generation 916, circuitry for RS (beam) selection 918, and circuitry for panel (antenna array) selection 920.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 7 and 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication, comprising:
determining at least one transmit power for transmission of one or more frames, the at least one transmit power being determined based on a first path loss associated with a first transmit direction and a second path loss associated with a second transmit direction;
generating the frames; and
transmitting the one or more frames in the first transmit direction and the second transmit direction using the determined transmit power.

2. The method of claim 1, wherein:
the first path loss is associated with a first antenna array for transmission in the first transmit direction; and
the second path loss is associated with a second antenna array for transmission in the second transmit direction, the one or more frames being transmitted in the first transmit direction and the second transmit direction via the first antenna array and the second antenna array.

3. The method of claim 2, further comprising:
receiving a first indication of the first antenna array;
receiving a second indication of the second antenna array;
determining the first path loss associated with the first antenna array based on a first reference signal associated with the first antenna array in response to the first indication; and
determining the second path loss associated with the second antenna array based on a second reference signal associated with the second antenna array in response to the second indication.

4. The method of claim 3, wherein:
the first indication of the first antenna array comprises an indication of a first sounding reference signal (SRS) resource of a first SRS resource set, the first SRS resource set being associated with the first antenna array;
the second indication of the second antenna array comprises an indication of a second SRS resource of a second SRS resource set, the second SRS resource set being associated with the second antenna array;
the first path loss is determined based on the first SRS resource; and
the second path loss is determined based on the second SRS resource.

5. The method of claim 1, wherein the first path loss is associated a first beam, and wherein the second path loss is associated with a second beam, the one or more frames being transmitted in the first transmit direction and the second transmit direction via the first beam and the second beam.

6. The method of claim 5, further comprising:
receiving an indication of a plurality of reference signal (RS)-resources from a RS-resource set;
selecting a first RS resource and a second RS resource from the plurality of RS-resources;
determining the first path loss associated with the first beam based on the first RS resource; and
determining the second path loss associated with the second beam based on the second RS resource.

7. The method of claim 1, wherein the at least one transmit power is determined based on a function of the first path loss and the second path loss.

8. The method of claim 7, wherein the function of the first path loss and the second path loss comprises at least one of:
an average of the first path loss and the second path loss;
a maximum of the first path loss and the second path loss; or
a minimum of the first path loss and the second path loss.

9. The method of claim 1, wherein the at least one transmit power is determined based on a first modulation and coding scheme (MCS) for transmission of the one or more frames in the first transmit direction and a second MCS for transmission of the one or more frames in the second transmit direction.

10. A method for wireless communication, comprising:
selecting an antenna array of a plurality of antenna arrays for transmission of one or more frames;
determining a transmit power for the transmission of the one or more frames via the antenna array, the transmit power being determined based on a path loss associated with the selected antenna array;
generating the one or more frames; and
transmitting the one or more frames via the antenna array using the determined transmit power.

11. The method of claim 10, further comprising:
receiving an indication of a plurality of reference signal (RS)-resources from a RS-resource set;
selecting an RS resource from the plurality of RS-resources; and
determining the path loss associated with the antenna array based on the selected RS resource.

12. The method of claim 11, wherein the plurality of RS-resources from the RS-resource set comprises a plurality of sounding reference signal (SRS)-resources from a SRS resource set.

13. The method of claim 11, wherein the indication is received via a RS resource indicator field of downlink control information (DCI).

14. The method of claim 10, wherein the transmit power is determined further based on a modulation and coding scheme (MCS) for transmission of the one or more frames via the selected antenna array.

15. An apparatus for wireless communication, comprising:
a processing system configured to:
determine at least one transmit power for transmission of one or more frames, the at least one transmit power being determined based on a first path loss associated with a first transmit direction and a second path loss associated with a second transmit direction;
generate the frames; and
a transmitter configured to transmit the one or more frames in the first transmit direction and the second transmit direction using the determined transmit power.

16. The apparatus of claim 15, wherein:
the first path loss is associated with a first antenna array for transmission in the first transmit direction; and
the second path loss is associated with a second antenna array for transmission in the second transmit direction, the one or more frames being transmitted in the first transmit direction and the second transmit direction via the first antenna array and the second antenna array.

17. The apparatus of claim 16, further comprising:
a receiver configured to:
receive a first indication of the first antenna array; and
receive a second indication of the second antenna array, wherein the processing system is further configured to determine the first path loss associated with the first antenna array based on a first reference signal associated with the first antenna array in response to the first indication, and determine the second path loss associated with the second antenna array based on a second reference signal associated with the second antenna array in response to the second indication.

18. The apparatus of claim 17, wherein:
the first indication of the first antenna array comprises a first indication of a first sounding reference signal (SRS) resource of a first SRS resource set, the first SRS resource set being associated with the first antenna array;
the second indication of the second antenna array comprises a second indication of a second SRS resource of a second SRS resource set, the second SRS resource set being associated with the second antenna array;
the first path loss may be determined based on the first SRS resource; and
the second path loss may be determined based on the second SRS resource.

19. The apparatus of claim 15, wherein the first path loss is associated a first beam, and wherein the second path loss is associated with a second beam, the one or more frames being transmitted in the first transmit direction and the second transmit direction via the first beam and the second beam.

20. The apparatus of claim 19, further comprising:
a receiver configured to receive an indication of a plurality of reference signal (RS)-resources from a RS-resource set, wherein the processing system is further configured to:
select a first RS resource and a second RS resource from the plurality of RS-resources;
determine the first path loss associated with the first beam based on the first RS resource; and
determine the second path loss associated with the second beam based on the second RS resource.

21. The apparatus of claim 15, wherein the at least one transmit power is determined based on a function of the first path loss and the second path loss.

22. The apparatus of claim 21, wherein the function of the first path loss and the second path loss comprises at least one of:
an average of the first path loss and the second path loss;
a maximum of the first path loss and the second path loss; or
a minimum of the first path loss and the second path loss.

23. The apparatus of claim 15, wherein the at least one transmit power is determined based on a first modulation and coding scheme (MCS) for transmission of the one or more frames in the first transmit direction and a second MCS for transmission of the one or more frames in the second transmit direction.

24. An apparatus for wireless communication, comprising:
a processing system configured to:
select an antenna array of a plurality of antenna arrays for transmission of one or more frames;
determine a transmit power for the transmission of the one or more frames via the antenna array, the transmit power being determined based on a path loss associated with the selected antenna array;
generate the one or more frames; and
a transmitter configured to transmit the one or more frames via the antenna array using the determined transmit power.

25. The apparatus of claim 24, further comprising:
a receiver configured to receive an indication of a plurality of reference signal (RS)-resources from a RS-resource set, wherein the processing system is further configured to:
selecte an RS resource from the plurality of RS-resources; and
determine the path loss associated with the antenna array based on the selected RS resource.

26. The apparatus of claim 25, wherein the plurality of RS-resources from the RS-resource set comprises a plurality of sounding reference signal (SRS)-resources from a SRS resource set.

27. The apparatus of claim 25, wherein the indication is received via a RS resource indicator field of downlink control information (DCI).

28. The apparatus of claim 24, wherein the transmit power is determined further based on a modulation and coding scheme (MCS) for transmission of the one or more frames via the selected antenna array.
